(19) United States
(12) Patent Application Publication
(10) Pub. No.: US 2010/0230120 A1
(43) Pub. Date: Sep. 16, 2010

(54) System and method for treating fires with encapsulated fire extinguishing agents

(76) Inventor: Leonard Silverstein, Atlanta, GA (US)

Correspondence Address: MCKENNA LONG & ALDRIDGE LLP, 1900 K STREET, NW, WASHINGTON, DC, 20006, US

(21) Appl. No.: 11/641,102

(22) Filed: Dec. 19, 2006

Related U.S. Application Data
(60) Provisional application No. 60/752,350, filed on Dec. 20, 2005.

(51) Int. Cl. A62C 31/00

(52) U.S. Cl. 169/52

(57) ABSTRACT

Disclosed is a system for extinguishing fires that uses a plurality of projectiles, which may be delivered to a fire from a safe distance. Each of the projectiles includes a shell that encapsulates a fire extinguishing agent. The shell may be designed to break apart on impact and/or when subjected to high temperatures. The fire extinguishing agent may include dry chemicals, powders, and the like. Also disclosed is a delivery device that propels a plurality of projectiles, like bullets from a gun, or like a stream of objects from a canister. By encapsulating the fire extinguishing agent within a shell, the projectiles may be more accurately and precisely directed to a fuel source of a fire, thereby extinguishing the fire more efficiently and with less collateral damage than in related art solutions.

### CROSS REFERENCE TO RELATED APPLICATION

This application claims priority to U.S. Provisional Application No. 60/752,350, filed Dec. 20, 2005, which is incorporated by reference as if fully disclosed herein.

### BACKGROUND OF THE INVENTION

1. Field of the Invention

The present invention generally relates to systems for extinguishing fires. More particularly, the present invention relates to systems for delivering fire extinguishing agents from a distance.

2. Discussion of the Related Art

Each year, many lives are lost, and a vast amount of property is destroyed, by fire. Fire department personnel are routinely put at risk in battling larger fires, in which effective application of fire extinguishing materials requires that a fire fighter be exposed to danger due to proximity to the fire.

Related art solutions to effective application of fire extinguishing materials typically involve portable nozzles or fixed piping systems, such as sprinkler systems. Also, aircraft may be used to apply fire retardants to large scale fires, such as forest fires.

One problem with related art solutions to applying fire extinguishing materials involves dispersion of the fire extinguishing material when being applied from a safe distance. For example, powders and dry chemicals, which are effective in extinguishing hydrocarbon fires, electrical fires, and the like, typically disperse in the intervening atmosphere between the application device and the fire. As such, depending on the distance from the application device (e.g., a nozzle) and the fire, only a limited percentage of the powder or dry chemical contacts the fire. Further, wind, which is likely in the event of a fire, may negatively affect the accuracy and precision in applying a dry chemical or powder. Also, in the case of fixed piping systems, they must be designed so that a sufficient amount of powder or dry chemical is applied to the fire from the nearest fixture. This may result in excessive powder or dry chemical being expended in order to extinguish the fire.

Another problem with related art solutions is that an excess amount of fire extinguishing material must be used in order to assure that enough will contact the fire. This may not only increase the costs in treating fires, but it may lead to unnecessary damage to property. Depending on the dry chemical or powder used, excessive use may also create a toxic environment that may provide an additional hazard to fire fighters and bystanders. For example, Purple-K, a dry chemical fire extinguishing agent that is very effective against Class B (flammable liquid) fires, forms a dry crust after combining with certain fluids, which can be very difficult to clean up.

Further, in the case of large fires, or fires having a moving fuel source, it can be very difficult to accurately and precisely pinpoint and apply fire extinguishing materials to the fuel source of the fire. This is due to the inherent inaccuracy and imprecision of related art solutions to applying fire extinguishing materials. A more precise and accurate mechanism for applying fire extinguishing materials would enable better pinpoint targeting of a fire's fuel source, even if that fuel source is moving.

Accordingly, what is needed is a system for accurately and precisely applying fire extinguishing materials to a fire from a safe distance.

### SUMMARY OF THE INVENTION

The present invention provides a system and method for treating fires with encapsulated fire extinguishing agents that obviates one or more of the aforementioned problems due to the limitations of the related art.

Accordingly, one advantage of the present invention is that it provides more accurate and precise application of a fire extinguishing material.

Another advantage of the present invention is that it reduces the amount of fire extinguishing material required to extinguish a fire.

Still another advantage of the present invention is that it reduces the collateral damage to property resulting from efforts to extinguish a fire.

Additional advantages of the invention will be set forth in the description that follows, and in part will be apparent from the description, or may be learned by practice of the invention. The advantages of the invention will be realized and attained by the structure pointed out in the written description and claims hereof as well as the appended drawings

To achieve these and other advantages, the present invention involves a fire extinguishing device. The fire extinguishing device comprises an outer shell; and a fire extinguishing agent encapsulated within the outer shell, wherein the outer shell is configured to release the fire extinguishing agent when the fire extinguishing device is delivered to a target area.

In another aspect of the present invention, the aforementioned and other advantages are achieved by a system for extinguishing a fire. The system comprises a delivery device; and a plurality of projectiles, wherein each of the projectiles has an outer shell and a fire extinguishing agent encapsulated within the outer shell, and wherein the outer shell is configured to release the fire extinguishing agent when the projectile is delivered to a target area.

In another aspect of the present invention, the aforementioned and other advantages are achieved by a fire extinguishing device. The fire extinguishing device comprises a outer shell; and a plurality of projectiles contained within the outer shell, wherein each of the plurality of projectiles has a projectile shell and a fire extinguishing agent encapsulated within the projectile shell, and wherein the projectile shell is configured to release the fire extinguishing agent when the projectile is delivered to a target area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A illustrates an exemplary seamless projectile according to the present invention;

FIG. 1B is a cutaway view of the seamless projectile of FIG. 1A;

FIG. 2 illustrates an exemplary seamed projectile;

FIG. 3 illustrates an exemplary projectile having a mesh-type shell;

FIG. 4A illustrates a seamless projectile having a plurality of dimples on its outer surface;

FIG. 4B illustrates a seamed projectile having a plurality of dimples on its outer surface;

FIG. 5A illustrates a seamless projectile having a plurality of ridges and a plug;

FIG. 5B illustrates a seamed projectile having a plurality of ridges and a plug;

FIG. 6 illustrates an exemplary gun-type delivery device;

FIG. 7 illustrates an exemplary centrifugal delivery device;

FIG. 8 illustrates an exemplary venturi-type delivery device;

FIG. 9 illustrates a projectile designed to break apart on impact;

FIG. 10 illustrates a projectile having a mesh-type shell being deployed in a fire; and

FIG. 11 illustrates a projectile shell containing a plurality of projectiles.

### DETAILED DESCRIPTION OF THE ILLUSTRATED EMBODIMENTS

The present invention involves projectiles that encapsulate a fire extinguishing material. The projectiles can be delivered to a target area, such as a fire, using the ballistic attributes of the projectile. The present invention also involves delivery devices that can be used to propel a plurality of projectiles to a target area from a safe distance.

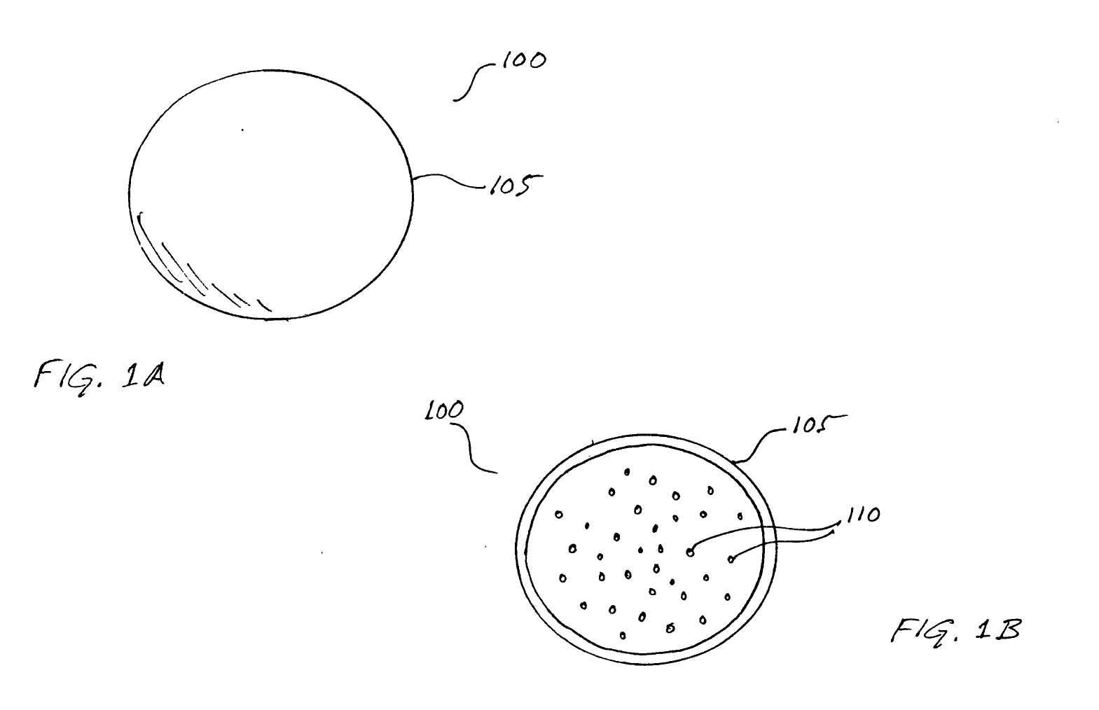

FIG. 1A illustrates an exemplary seamless projectile 100 according to the present invention. FIG. 1B is a cutaway view of projectile 100. Projectile 100 includes a shell 105 and an inner volume that includes a fire extinguishing agent 110. Fire extinguishing agent 110 may include a powder, cryogenic solids, inert solids, dry chemicals, slurries, liquids, and the like. Fire extinguishing agent 110 may be a mixture of agents, depending on the type of fire to be extinguished. Further, fire retardant agent 110 may be a mixture of agents that will give projectile 100 particular physical properties. For example, fire retardant agent 110 may include a combination of agents having a low density so that seamless projectile 100 may float. One skilled in the art will readily appreciate that many such variations to fire retardant agent 110 are possible and within the scope of the invention.

Shell 105 may be designed to break open on impact. Further, shell 105 may be designed to open when exposed to high temperature. Shell 105 may include a gel, a polymer, a pharmaceutical grade material, an animal grade material, a thin rigid plastic material, and the like. Shell 105 may include stress points to assist in breaking open projectile 100 on impact. The diameter and thickness of shell 105 may vary, depending on factors such as, for example, the intended method of delivering projectile 100, the speed at which projectile 100 will be delivered to the target area, and the fire extinguishing agent 110 used. For example, if projectile 100 is intended to be dropped from an aircraft onto a forest fire, shell 105 may be designed with sufficient thickness to withstand the aerodynamic stresses of the descent from the aircraft. Further, in the case of projectile 100 being dropped from an aircraft, it may be desirable to design projectile 100 to have a terminal velocity sufficient to assure that shell 105 will break open on impact on a relatively soft surface, such as forest ground cover.

Shell 105 may be substantially spherical in shape, or it may take a variety of shapes. For example, shell 105 may have a ballistic shape, like that of an artillery shell, to improve its aerodynamic penetration and to make its trajectory less susceptible to crosswinds and other intervening factors. Other shapes may include cylinders, cones, oblongs, cubes, etc. Another factor in determining the shape of shell 105 may include how projectile 100 is to be delivered. For example, projectile 100 may be fired in a salvo like from a shotgun, or may be fired in a rapid serial stream like from a machine gun. In the latter case, it may be desirable to design shell 105 so that it is substantially spherical and rigid. One skilled in the art will readily recognize that many such variations to the shape of shell 105 are possible and within the scope of the invention.

Projectile 100 may be substantially seamless, as illustrated in FIG. 1A. In this case, shell may be manufactured using a blow molding technique.

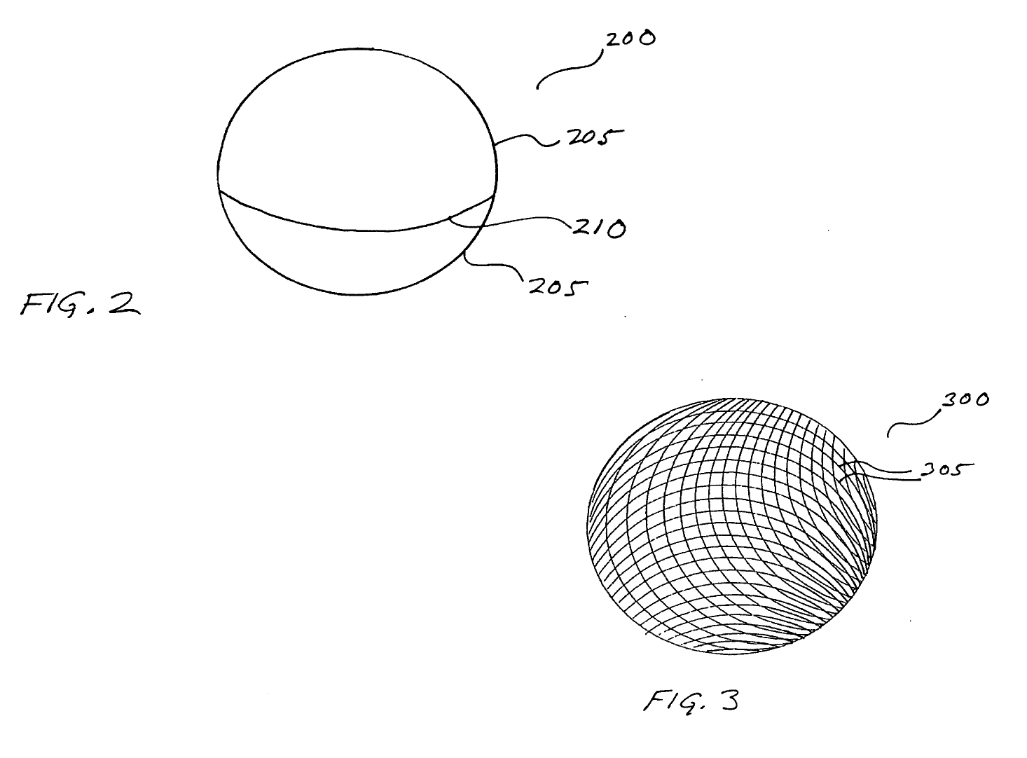

FIG. 2 illustrates a seamed projectile 200. Seamed projectile 200 may include shell segments 205 that fit together to form a sealed shell having a seam 210. The use of shell segments 205 may enable easier manufacturing of seamed projectile 200 relative to projectile 100. Further, the presence of seam 210 may enable seamed projectile 200 to more easily break open on impact. Shell segments 205 may fit together so that they join each other at seam 210. Shell segments 205 may include a slot or similar structure so that shell segments 205 overlap at seam 210. Further, shell segments 205 may each be substantially hemispheric, as illustrated in FIG. 2. Alternatively, shell segments 205 may be asymmetric such that a first shell segment may encompass a majority of the area of seamed projectile 200, and a second shell segment may be like a lid or cap that is attached to the first shell segment after fire extinguishing agent is injected into first shell segment. Additionally, projectile 200 may have more than two shell segments 205. Multiple shell segments 205 may be used, for example, to ease manufacture of projectile 205.

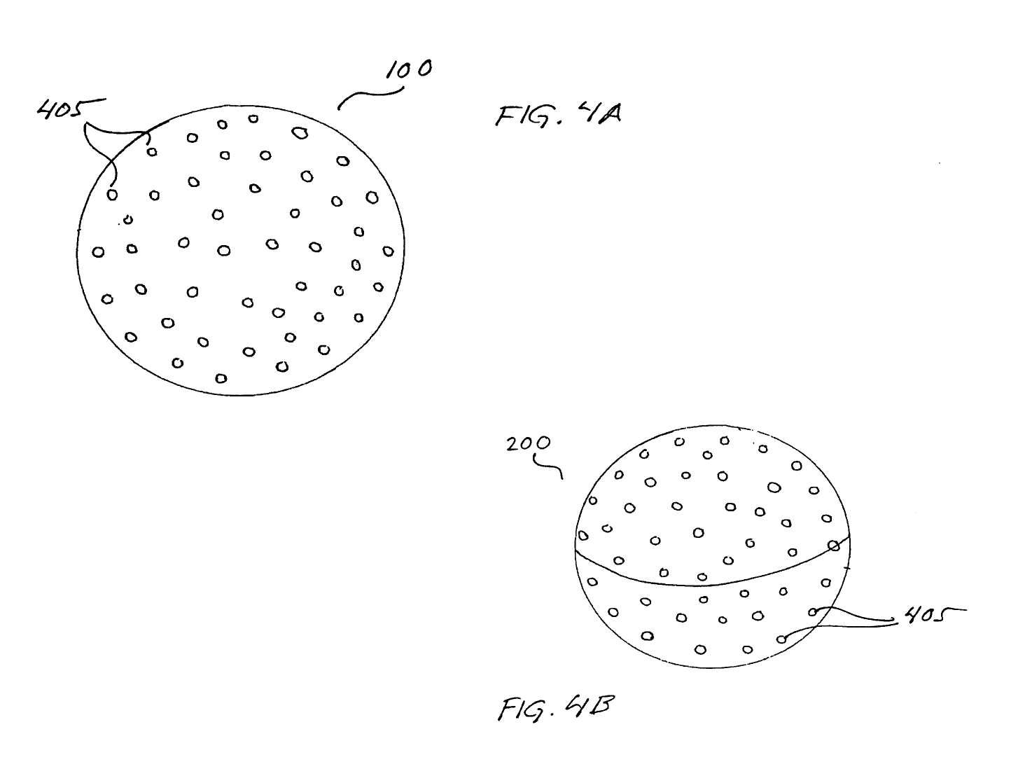

FIG. 3 illustrates an exemplary projectile 300, which has a mesh-type shell 305. Mesh-type shell 305 may permit the encapsulated fire extinguishing agent 110 to escape through the shell. Mesh-type shell 305 need not break open to release fire extinguishing agent 110. Mesh-type shell 305 may include a material that melts in high heat. This may enable mesh-type shell 305 to better contain encapsulated fire extinguishing agent 110 when projectile 300 is being stored and handled, while enabling it to release fire extinguishing agent 110 when deployed in a fire. Further, mesh-type shell 305 may include metal, such as wire, whereby when projectile 300 is delivered to a fire, fire extinguishing agent 110 may diffuse through mesh-type shell 305. A metal mesh-type shell 305 may be used to encapsulate a cryogenic fire extinguishing agent, such as dry ice pellets. In this case, the cryogenic fire extinguishing agent 110 may diffuse through mesh-type shell 305 via sublimation.

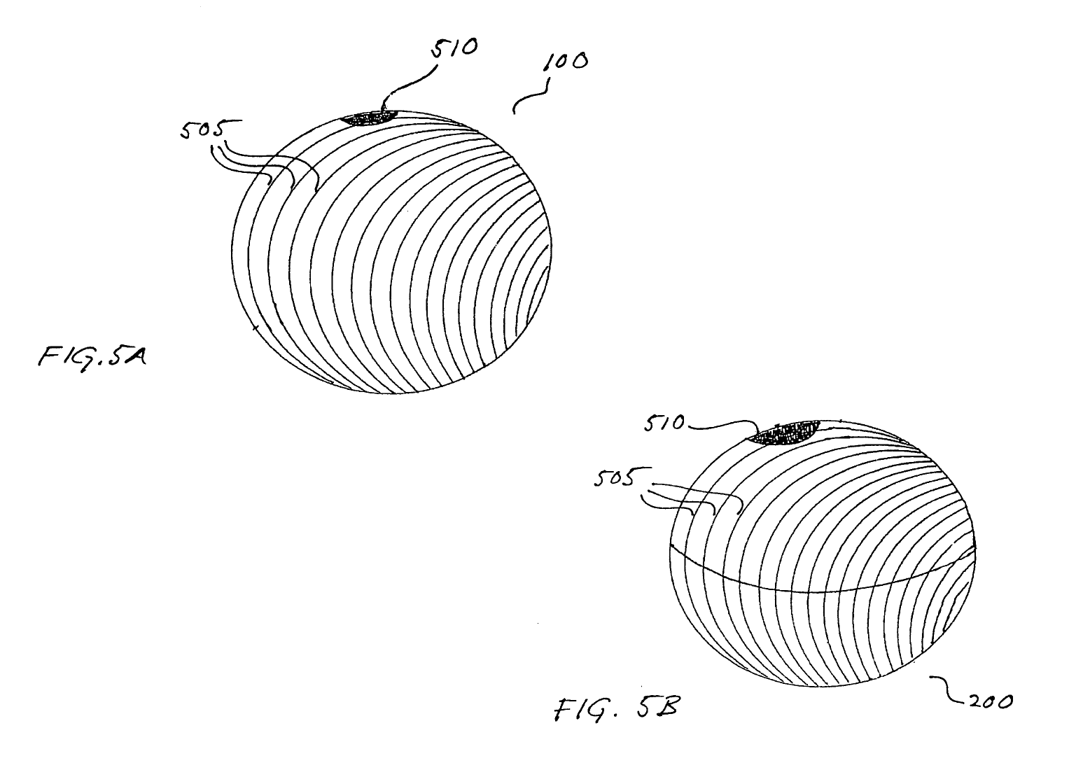

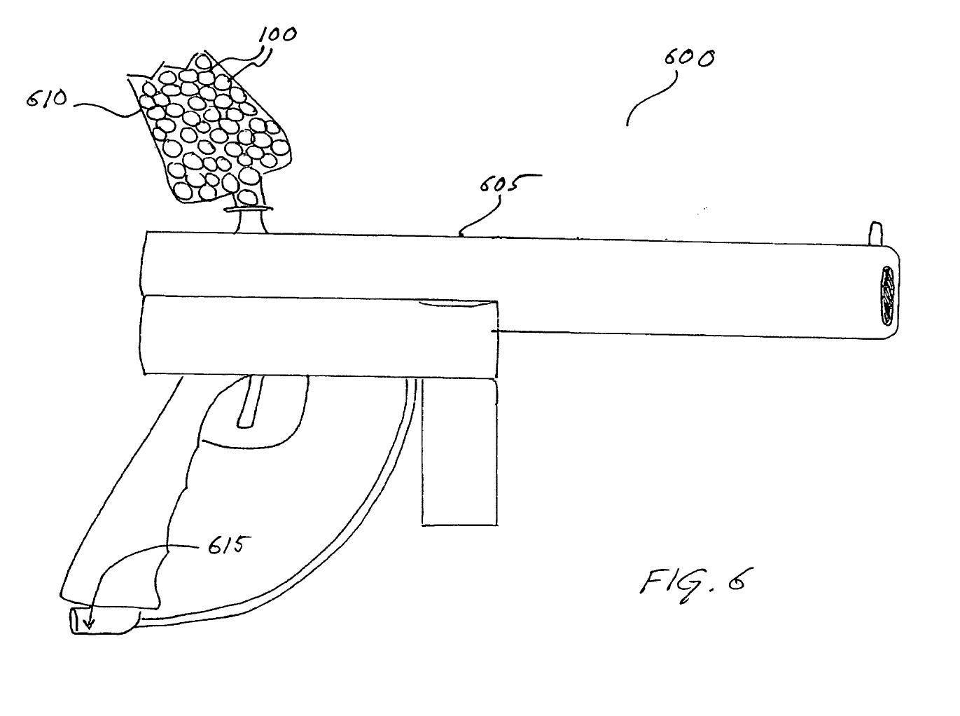

FIGS. 4A and 4B respectively illustrate projectiles 100 and 200 having a plurality of dimples 405 disposed on the outer surface of their respective shells. Dimples 405 may be substantially similar to the features found on golf balls. Dimples 405 may assist in controlling the trajectory of projectile 100/200, as well as in increasing the distance traveled by projectile 100/200.

FIGS. 5A and 5B respectively illustrate projectiles 100 and 200 having a plurality of ridges 505 disposed on the outer surfaces of their respective shells. Ridges 505 may assist in controlling the trajectory of projectile 100/200, as well as in increasing the distance traveled by projectile 100/200. Other features apart from dimples 405 and ridges 505 are possible and within the scope of the invention.

FIGS. 5A and 5B further illustrate a plug 510. As illustrated in FIGS. 5A and 5B, plugs 510 are respectively coupled to the shell 105 of projectiles 100 and to one of the shell segments 205 of projectile 200. Plug 510 may be used to seal a hole created in shell/shell segment 105/205 to fill projectiles 100/200 with fire extinguishing agent 110. Although FIGS. 5A and 5B illustrate plugs 510 coupled to projectiles 100/200 having ridges 505, it will be readily apparent to one skilled in the art that plug 510 may be used with any of the projectiles 100/200/300 described above, regardless of the presence of features such as dimples 405 and ridges 505.

FIG. 6 illustrates a gun-type delivery device 600 for delivering projectiles according to the present invention. Gun-type delivery device 600 may include a projectile gun 605, which may operate in single-shot, semiautomatic, or automatic mode. Projectile gun 605 may include a feeder system 610, which contains a plurality of projectiles 100. Feeder system 610 may use gravity to feed projectiles into projectile gun 605, although other techniques may be used. Although projectiles 100 are shown in feeder system 610, feeder system 610 may hold any combination of projectiles 100/200/300 described above.

Projectile gun 605 may be in the form of a pistol, shotgun, machine gun, gattling gun, cannon, multiple barrel device, and the like. An exemplary projectile gun 605 may be substantially similar to a “paint-ball” gun. Projectile gun 605 may use a propellant canister 615, containing a gas such as cryogenic carbon dioxide or nitrogen, which provides propellant for delivering projectiles 100 to a fire. Projectile gun 605 may use other forms of propellant, such as pressurized air or gas. Propellant canister 615 may attach directly to projectile gun 605, or it may be connected to projectile gun 605 by a flexible hose (not shown). A flexible hose enables propellant canister 615 to be worn by a user like a backpack, which may increase the amount of propellant available to the user. One skilled in the art will readily recognize that many such variations to delivery device 600 are possible and within the scope of the invention.

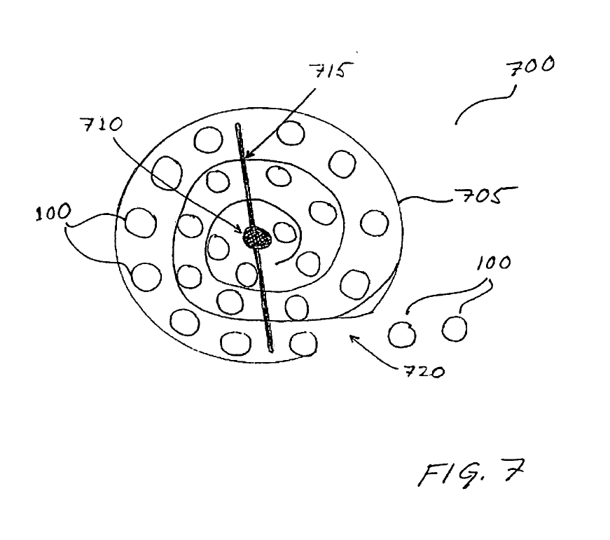

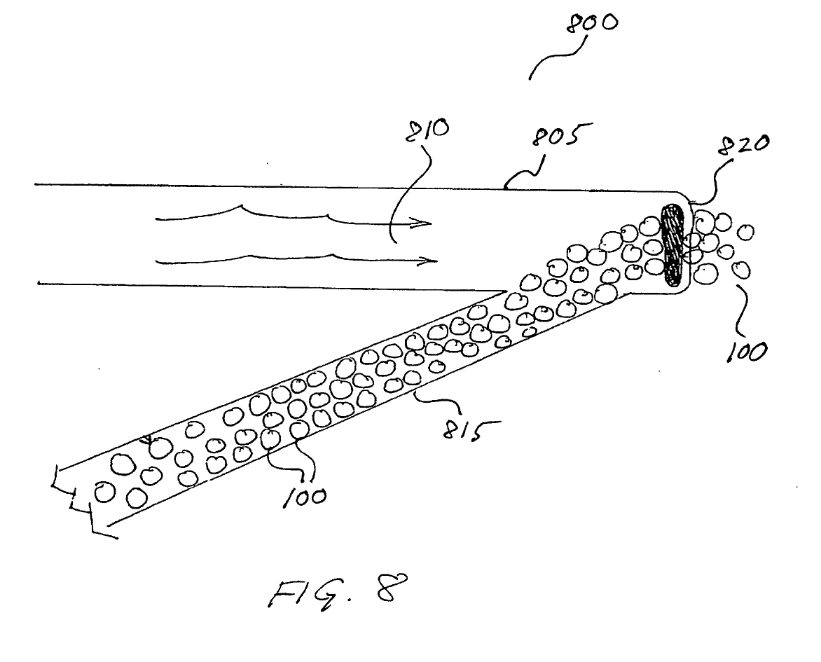

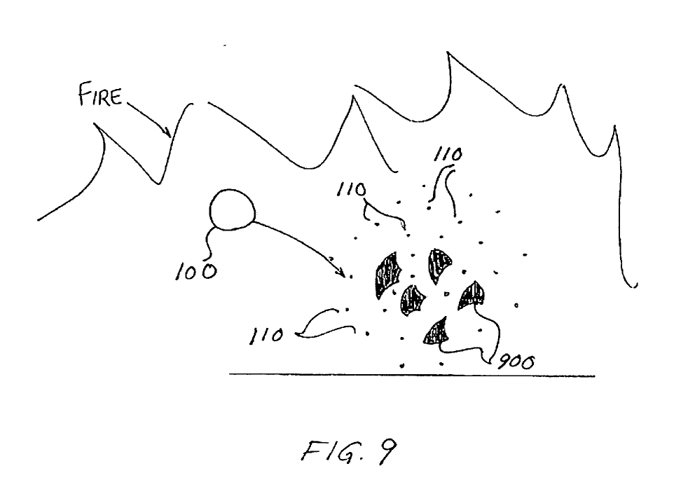

FIG. 7 illustrates an exemplary centrifugal delivery device 700 according to the present invention. Centrifugal delivery device 700 includes a spiral chamber 705 having a nozzle 720, a feeder 710, a paddle 715, and a plurality of projectiles 100. Feeder 710 may include a canister (not shown) containing a plurality of projectiles 100, and a tube that serially inserts projectiles 100 into the center of spiral chamber 705. Centrifugal delivery device 700 may work as follows. Feeder 710 inserts a projectile 100 into the center of spiral chamber 705, such that the projectile 100 enters a queue of projectiles 100. Paddle 715 rotates, either by use of a motor (not shown) or a manual crank (not shown), thereby pushing the plurality of projectiles 100 outward through spiral chamber 705. As paddle 715 pushes each of the plurality of projectiles 100 outward through spiral chamber 705, each projectile 100 gains speed as it approaches nozzle 720. Accordingly, as paddle 715 rotates, centrifugal delivery device 700 emits a serial stream of projectiles 100. Although this description of centrifugal delivery device 700 describes the use of projectiles 100, it will be readily apparent to that any of the aforementioned projectiles 100/200/300 may be used.

FIG. 8 illustrates an exemplary verturi-type delivery device 800. Venturi-type delivery device 800 includes a propellant channel 805 having a nozzle 820, a propellant gas 810, a projectile feeder 815, and a plurality of projectiles 100. Propellant gas 810 may include a stream of pressurized air or cryogenic gas, such as carbon dioxide or nitrogen, although other fluids, such as water, may be used provided that it can propel a stream of projectiles 100 through projectile feeder 815 and out through nozzle 820. Venturi-type delivery device 800 may provide a relatively high rate of projectile 100 delivery because nozzle 820 may emit multiple projectiles 100 simultaneously. Accordingly, venturi-type delivery device 800 may deliver a spray of projectiles 100 toward a fire.

Another exemplary delivery device may include a standard fire extinguisher, which is modified to contain a plurality of projectiles 100. The fire extinguisher may be modified to be held upside down when delivering projectiles. By using projectiles, and by holding the fire extinguisher upside down, the required pressure for the propellant within the fire extinguisher may be reduced relative to that of a standard fire extinguisher. Reducing the required propellant pressure may allow the fire extinguisher canister to be made of a lighter material, such as plastic, instead of steel, which is used in typical fire extinguisher canisters.

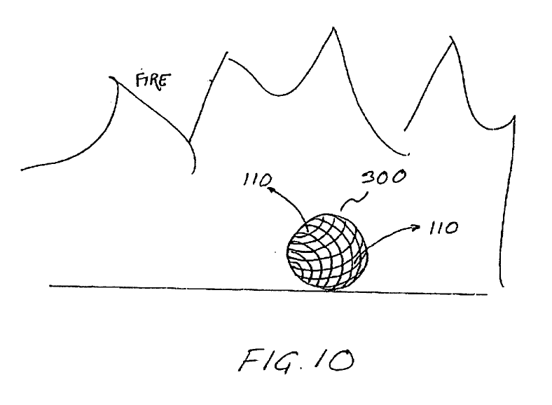

FIG. 9 illustrates a projectile 100 breaking apart on impact within a fire. In this case, projectile 100 is designed to break apart on impact. As illustrated in FIG. 9, projectile 100 breaks apart on impact, resulting in the release of fire extinguishing agent 100 and a plurality of shell fragments 900.

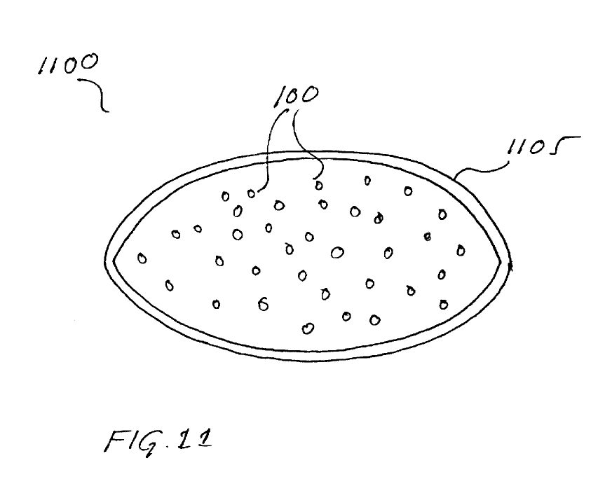

FIG. 10 illustrates a projectile 300 having a mesh-type shell 305 being deployed in a fire. In this case, the encapsulated fire extinguishing agent 110 is released into the fire through the mesh-type shell 305.

FIG. 11 illustrates a projectile shell 1100 containing a plurality of projectiles 100. Projectile shell 1100 includes an outer shell 1105, which encapsulates a plurality of projectiles 100. Projectile shell 1100 may be used in applications in which it is required to deliver a large number of projectiles 100 into a limited area from a great distance. For example, projectile shell 1100 may be fired from an artillery-like launching device. Further, projectile shell 1100 may be dropped from an aircraft into a fire that has a fuel source in a known and hard-to-reach location. In this case, the aircraft may drop projectile shell 1100 in a manner similar to air-dropped ordnance. This may enable precise application of fire extinguishing agent 110 onto a fuel source of a large fire, such as a burning oil well. Outer shell 105 may have a ballistic shape or an aerodynamic shape, which may increase the terminal velocity of projectile shell 1100 and reduce the effects of crosswinds and the like. Outer shell 105 may be designed to break apart on impact. Also, outer shell 1105 may have a weight or ballast (not shown) that may increase aerodynamic penetration of projectile shell 1100 and provide for “pointing” of projectile shell as it moves through the atmosphere. Further, although projectile shell 1100 is shown as containing a plurality of projectiles 100, one skilled in the art will readily appreciate that any combination of projectiles 100/200/300 may be used.

Variations to any of the above-described projectiles are possible. For example, any of the above-described shells may contain one or more air-filled (or gas-filled) balls, or other material having a low specific density, in addition to the fire extinguishing agent. These air-filled balls may increase the buoyancy of the projectile, making it more suitable for treating surface fires, such as fuel burning on the surface of water, or a burning structure surrounded by water. In this case, the projectile may float on a surface, such as the surface of water or fuel. Further, in the case of a fuel floating on water, the projectile may float on the fuel's surface. Additionally, an additive may be included in the liquid fire extinguishing agent to enable the projectile to float. Examples of additives include vermiculite or perlite.

Although the above describes the present invention being used to extinguish fires, the present invention may be used to prevent fires in areas at risk. Here, the target area may include an endangered structure near a fire, or an area surrounding a fire. In this case, fire extinguishing agent 110 may be a fire retarder, or a material that may prevent the structure from catching fire. Other applications include delivering chemicals to treat a hazardous material spill. For example, projectile 300 having a cryogenic fire extinguishing agent 110 (described above) may include one or more air or gas-filled spheres that may enhance the buoyancy of projectile 300. Alternatively, projectile 300 may be configured so that its specific density is less than that of water. In either case, a plurality of projectiles 300 may be delivered to an oil slick. Once the plurality of projectiles 300 are delivered to the oil slick, the cryogenic material diffuses through mesh-type shell 305. When the cryogenic material contacts the oil, it congeals the oil into a solid or semi-solid material. The solid or semi-solid material may then be removed from the water more easily than an oil slick floating on the water's surface. One skilled in the art will readily appreciate that such applications are possible and within the scope of the invention.

In another variation, any of the above-described delivery devices 600/700/800 may be integrated into a fixed piping system, such as a sprinkler system. In this case, delivery devices 600/700/800 may be activated automatically. Further, delivery devices 600/700/800 may be aimed via remote control or by an automated targeting system.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A fire extinguishing device, comprising:
an outer shell; and
a fire extinguishing agent encapsulated within the outer shell,
wherein the outer shell is configured to release the fire extinguishing agent when the fire extinguishing device is delivered to a target area.

2. The fire extinguishing device of claim 1, wherein the outer shell is configured to break apart on impact.

3. The fire extinguishing device of claim 1, wherein the outer shell is configured to break apart when exposed to heat.

4. The fire extinguishing device of claim 1, wherein the outer shell comprises a gel.

5. The fire extinguishing device of claim 1, wherein the outer shell comprises a polymer.

6. The fire extinguishing device of claim 1, wherein the outer shell comprises plastic.

7. The fire extinguishing device of claim 1, wherein the outer shell comprises a pharmaceutical grade material.

8. The fire extinguishing device of claim 1, wherein the outer shell comprises a plurality of dimples.

9. The fire extinguishing device of claim 1, wherein the outer shell comprises a plurality of ridges.

10. The fire extinguishing device of claim 1, wherein the outer shell comprises at least two shell segments that are joined together.

11. The fire extinguishing device of claim 1, wherein the outer shell comprises a plug.

12. The fire extinguishing device of claim 1, wherein the fire extinguishing agent comprises a dry chemical.

13. The fire extinguishing device of claim 1, wherein the outer shell comprises a mesh.

14. The fire extinguishing device of claim 13, wherein the fire extinguishing agent comprises a cryogenic material.

15. The fire extinguishing device of claim 14, wherein the fire extinguishing agent comprises dry ice pellets.

16. The fire extinguishing device of claim 14, further comprising an additive added to the fire extinguishing agent.

17. The fire extinguishing device of claim 13, wherein the fire extinguishing agent comprises a liquid.

18. The fire extinguishing device of claim 1, wherein fire extinguishing device has a specific density that enables the fire extinguishing device to float.

19. The fire extinguishing device of claim 1, wherein the outer shell comprises a substantially spherical shape.

20. A system for extinguishing a fire, comprising:
a delivery device; and
a plurality of projectiles, wherein each of the projectiles has an outer shell and a fire extinguishing agent encapsulated within the outer shell, and wherein the outer shell is configured to release the fire extinguishing agent when the projectile is delivered to a target area.

21. The system of claim 20, wherein the delivery device comprises:
a projectile gun;
a projectile feeder coupled to the projectile gun, wherein the projectile feeder contains the plurality of projectiles.

22. The system of claim 21, further comprising a propellant canister connected to the projectile gun.

23. The system of claim 20, wherein the delivery device comprises:
a spiral chamber having a nozzle;
a feeder that feeds projectiles into the spiral chamber; and
a paddle that is configured to rotate within the spiral chamber.

24. The system of claim 20, wherein the delivery device comprises:
a propellant channel having a nozzle;
a propellant gas source coupled to the propellant channel; and
a projectile feeder coupled to the propellant channel.

25. The system of claim 20, wherein the outer shell of each of the plurality of projectiles is configured to break open on impact.

26. The system of claim 20, wherein each of the plurality of projectiles comprises at least one gas-filled pellet.

27. The system of claim 20, wherein each of the plurality of projectiles comprises at least one air-filled pellet.

28. A fire extinguishing device, comprising:
a outer shell; and
a plurality of projectiles contained within the outer shell,
wherein each of the plurality of projectiles has a projectile shell and a fire extinguishing agent encapsulated within the projectile shell, and wherein the projectile shell is configured to release the fire extinguishing agent when the projectile delivered to a target area.

29. The fire extinguishing device of claim 28, wherein the outer shell is configured to break open on impact.

30. The fire extinguishing device of claim 28, wherein the outer shell is configured to break apart when exposed to heat.

31. The fire extinguishing device of claim 28, wherein the projectile shell comprises a mesh.

32. The fire extinguishing device of claim 28, wherein the fire extinguishing agent comprises a dry chemical.

33. The fire extinguishing device of claim 32, wherein the fire extinguishing agent further comprises additives.

34. The fire extinguishing device of claim 28, wherein the fire extinguishing agent comprises a liquid.
